(19) United States
(12) Patent Application Publication
(10) Pub. No.: US 2008/0025401 A1
(43) Pub. Date: Jan. 31, 2008

(54) Method for measuring real-time image complexity

(75) Inventors: Chang-Hyun Lee, Seoul (KR); Jae-Seok Kim, Seoul (KR); Seong-Joo Lee, Seoul (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/880,203

(22) Filed: Jul. 20, 2007

(30) Foreign Application Priority Data
Jul. 27, 2006 (KR) 70862/2006

(51) Int. Cl. H04N 7/12

(52) U.S. Cl. 375/240.16; 375/E07.076

(57) ABSTRACT

A method for measuring an real-time image complexity of an image processed for each macroblock based on a frame includes: identifying a state of a preset value among header bits of information processed for each macroblock in a preceding frame; identifying a state of the preset value among header bits of information processed for each macroblock up to a preceding frame; and detecting image complexity of a current frame through comparison of the identified states.

### CLAIM OF PRIORITY

This application claims the benefit of an application entitled “Method for Measuring Real-Time Image Complexity,” filed in the Korean Intellectual Property Office on Jul. 27, 2006 and assigned Serial No. 2006-70862, the contents of which are hereby incorporated by reference.

### BACKGROUND OF THE INVENTION

1. Field of the Invention

The present invention relates to video encoding technology, and more particularly to a method of measuring real-time image complexity, which is used in controlling the video encoding data rate when a low bit rate and a high frame rate occur.

2. Description of the Related Art

Various digital video compression technologies have been proposed in order to acquire high-quality image and a low data rate when transmitting or storing video signals. Known video compression technologies are international standards, such as H.261, H.263, H.264, MPEG-2 and MPEG-4 etc. These compression technologies provide relatively high compression rates at present through a Discrete Cosine Transform (DCT) scheme or a Motion Compensation (MC) scheme, and so on. These video compression technologies are used for efficient transfer of video data streams to various digital networks, for example, a mobile phone network, a computer network, a cable network, a satellite network and the like. Also, these video compression technologies are employed to efficiently store video data streams in storage media, such as a hard disk, an optical disk, a Digital Video Disk (DVD), and so on.

In order to accomplish the high-quality image, there is a demand for a large amount of data when video encoding is performed. However, a data rate usable for encoding may have a limit in a communication network when used for transferring video data. For instance, data channels of either a satellite system or a digital cable television network usually transmit data at a Constant Bit Rate (CBR). Also, storage capacity of storage media, such as a disk, is limited.

Accordingly, a video encoding process performs appropriate trade-off between an image quality and the number of bits required for image compression under current limitation. Since the video encoding requests a comparative complicated process, for example, when a video encoding is intended to be implemented by software, the video encoding process needs a comparatively large amount of CPU cycles. Moreover, in reproducing the encoded video data in real time, the time limits the performance of precision in the encoding, thereby limiting an obtainable image quality.

The video encoding data rate control is an important matter in actual use environment. A video encoding data rate control scheme is proposed for not only reducing the complexity of the processing scheme and the transmitting data rate but also obtaining images having a quality as high as possible.

In general, the video encoding data rate control has been made on the assumption that an image within Group of Picture (GOP) does not change drastically. Joint Video Team (JVT: ITU-T Video Coding Experts Group and ISO/IEC 14496-10 AVC Moving Picture Experts Group, Z. G. Li, F. Pan, K. P. Lim, G Feng, X. Lin, and S. Rahardja, “Adaptive basic unit layer rate control for JVT”, JVT-G012-r1, 7^{th} Meeting Pattaya II, Thailand, March 2003.) discloses a basic technology for controlling data rate through adjustment of Quantization Parameter (QP) when video frame encoding is performed according to an MPEG video compression algorithm.

A rate control particularly has a great influence on video encoding performance in an application field having limited allocatable bit resources. Given bit resources are mainly distributed based on the frame unit of an image. An image frame having high complexity is allocated with ample bit resources in order to maintain a high quality of coded image. On the contrary, an image frame having low complexity requires comparatively less bit resources. Therefore, a measurement of complexity of image frame is an important parameter which in turn determines performance of the rate control.

Accordingly, there is a need for more accurately and efficiently measuring the image complexity.

### SUMMARY OF THE INVENTION

Accordingly, the present invention has been made to solve the above-mentioned problems occurring in the prior art and provides additional advantages, by providing a method capable of more accurately and efficiently measuring image complexity in an application field having a given low bit rate and a high frame rate.

In accordance with an aspect of the present invention, there is provided a method for measuring an real-time image complexity of an image processed for each macroblock based on a frame, the method comprising the steps of: identifying a state of a preset value among header bits of information processed for each macroblock in a preceding frame; identifying a state of the preset value among header bits of information processed for each macroblock up to a preceding frame; and detecting image complexity of a current frame through comparison of the identified states.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a video encoder to which the present invention is applied;

FIG. 2 is a flowchart illustrating an operation of measuring image complexity at the time of conventional video encoding; and

FIG. 3 is a flowchart illustrating an operation of measuring image complexity during video encoding according to an embodiment of the present invention.

### DETAILED DESCRIPTION OF THE INVENTION

Hereinafter, an exemplary embodiment according to the present invention will be described with reference to the accompanying drawings. In the below description, many particular items such as a detailed component apparatus are shown, but these are given only for providing the general understanding of the present invention, it will be understood by those skilled in the art that the present invention can be embodied without including these particular items.

According to a process of Rate Distortion Optimization (RDO) of H.264/AVC, an inter mode or intra mode is selected for each macroblock in an inter frame. The JVT mentioned above cannot relatively reflect the complexity within an image so that it cannot produce optimal performance in images having a lot of motion. In “M. Jiang, X. Yi, and N. Ling, “Improved frame-layer rate control for H.264 using MAD ratio,” IEEE International Symposium on Circuits and Systems, vol. 111, pp. 813-816, May 2004, Vancouver, Canada,” the image complexity is measured based on the information coded for each macroblock, and the defects of the JVT are improved by reflecting the measured image complexity. The information coded for each macroblock includes header bits and texture bits. Jiang's method for measuring image complexity which can be applied to rate control of H.264/AVC can be obtained by the following Equation (1) through analysis of texture-bits.

$${RatioMAD}_{i} = \frac{{PMAD}_{i}}{( \frac{1}{i - 1} ) {\sum }_{j = 1}^{i - 1} {CMAD}_{j}} \qquad ( 1 )$$

In equation (1), PMAD refers to Predicted Mean Absolute Difference, and CMAD refers to actually Computed Mean Absolute Difference. Also, ‘i’ refers to a frame number of a current frame and ‘j’ refers to a frame number of the frame just preceding the current frame. That is, according to Equation (1), the RatioMAD, i.e., image complexity corresponds to a ratio of PMAD of the current frame (i^{th}) to an average value of CMAD up to the preceding frame. Here, the CMAD is calculated using information about an error between corresponding input frame of the preceding frame and a reconstructed frame. The PMAD corresponds to a predicted value of MAD of the current frame by using variation states, etc. of the calculated CMADs of preceding frames.

In this manner, Jiang, etc., provides the method of measuring image complexity which can be applied to rate control of H.264/AVC. However, because this method analyzes only the texture bits, this method has a decreased accuracy in an application field having a given low bit rate and a high frame rate. Hereinafter, the problems of measuring image complexity according to existing technologies will be described in more detail below.

First, according to a bit stream structure of H.264/AVC, a bit stream is coded slice by slice. One slice includes a slice header field and a slice data field, wherein the slice data field includes a plurality of macroblock fields. One macroblock field represents the image information of one macroblock, and includes a macroblock header field and a texture data field. The macroblock header field can be classified into ‘mb_type’ field and ‘mb_pred’ field.

A value representing a kind of a macroblock is recorded in the ‘mb_type’ field. That is, the ‘mb_type’ field represents whether a current macroblock corresponds to an intra macroblock or an inter macroblock. The information about a detailed prediction mode according to a kind of the macroblock is recorded in the ‘mb_pred’ field. When the macroblock above is an intra macroblock, the selected intra prediction mode is recorded. When the macroblock above is an inter macroblock, the information about motion vector, etc. according to macroblock partition and a reference frame number is stored. The texture field stores coded data of the rest of the frame, that is, stores texture data.

The ratio of image complexity to a header bit (the number of bits used in a header field) in an application field having a given low bit rate and a high frame rate gradually increases as compared with the entire number of bits (the number of bits of header field +the number of bits of texture field). The following Table 1 shows the ratio of entire encoded bits to the header bits when a frame rate is 30 fps (frame per second) and bit rate decreases.

TABLE 1

| Bit rate | Carphone | Foreman | Salesman | Silent | Trevor |
|---|---|---|---|---|---|
| 76.8 kbps | 33.2% | 34.9% | 19.9% | 25.6% | 29.0% |
| 38.4 kbps | 37.5% | 43.0% | 25.1% | 29.2% | 34.3% |
| 19.2 kbps | 41.8% | 46.1% | 25.9% | 33.1% | 38.8% |

In Table 1, when bit rates are 76.8 kbps, 38.4 kbps and 19.2 kbps, respectively, the ratio of the entire encoded bits to the header bits is identified from the examples of random test sequence images, what is called, ‘Carphone’, ‘Foreman’ ‘Salesman’ and ‘Trevor’. As shown in Table 1, as the bit rate decreases, i.e., as the number of available bits decreases, the ratio of the header bit relatively increases. The ratio further increases in images having a lot of motion, such as ‘Carphone’ and ‘Foreman.’ Accordingly, it is desirable to consider the header bits for the image having a low bit rate and a high frame rate when measuring the image complexity.

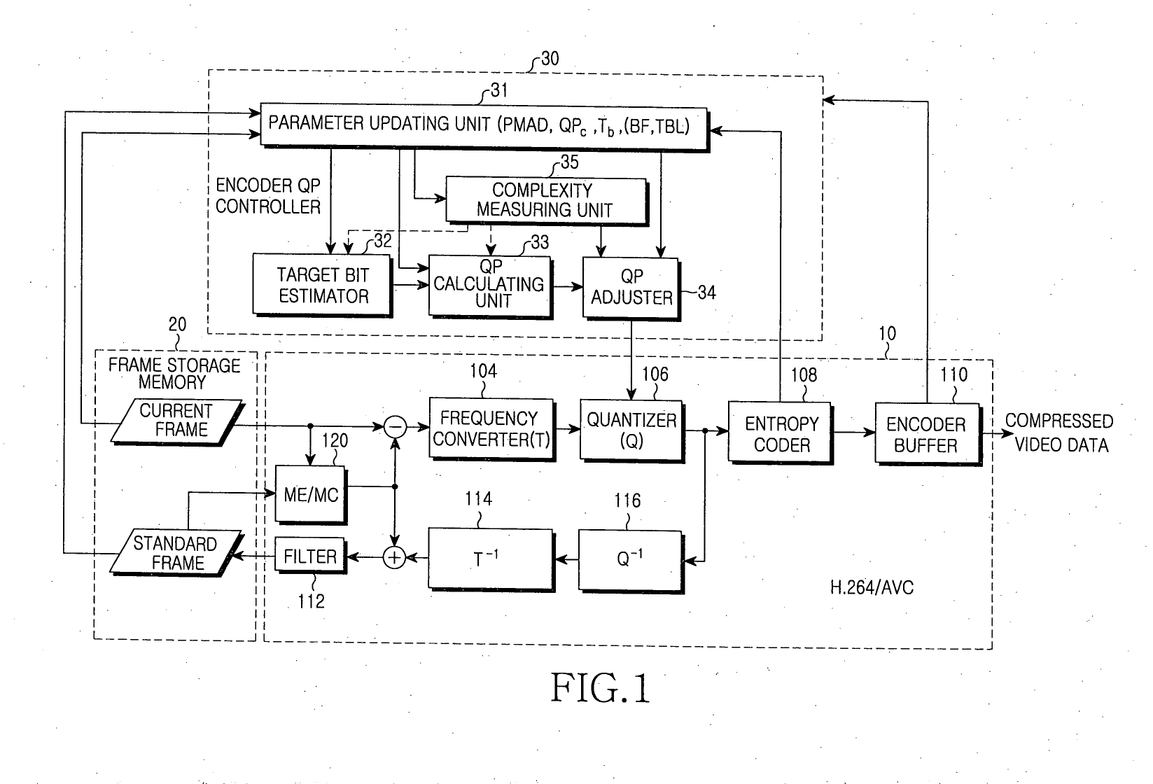

The present invention proposes a method of measuring image complexity, which can reflect not only texture bits but also header bits when measuring the image complexity in an application field having a given low bit rate and a high frame rate. A video encoder according to the present invention will be described with reference to FIG. 1 .

FIG. 1 is a block diagram illustrating a video encoder where the embodiment of the present invention is applied. As shown, the video encoder may include a general H.264/Advanced Video Coding (AVC) encoder 10 which receives a video frame sequence and outputs a compressed video data. The video encoder further includes a frame storage memory 20 for storing frames and an encoder Quantization Parameter (QP) controller 30 for performing the QP control operation for data rate control of the encoder 10.

First, a configuration and operation of the encoder 10 will be described in more detail. The encoder 10 includes a frequency converter 104, a quantizer 106, an entropy coder 108, an encoder buffer 110, a dequantizer 116, an inverse frequency converter 114, a Motion Estimator/Motion Compensator (ME/MC) 120, and a filter 112.

When a current frame corresponds to an inter frame (e.g., a P frame), a ME/MC 120 estimates and compensates a motion of the macroblock within the current frame with respect to a reference frame, i.e., a reconstructed frame from a preceding frame buffered in the frame storage memory 20. The frame is processed for each macroblock corresponding to a pixel of an original image (e.g., 16-by-16 pixel). Each macroblock is coded into either intra mode or inter mode. In estimating a motion, motion information such as a motion vector is output as additional information. In compensating a motion, a motion-compensated current frame is created by applying motion information to the reconstructed preceding frame. In this manner, the difference between the macroblock of the motion-compensated current frame (estimation macroblock) and the macroblock of the original current frame is provided to a frequency converter 104.

The frequency converter 104 converts video information of the space domain into the frequency domain (e.g., spectrum) data. In this case, the frequency converter 104 usually performs Discrete Cosine Transform (DCT), thereby creating a DCT coefficient block macroblock by macroblock.

A quantizer 106 quantizes a spectrum data coefficient block output by the frequency converter 104. In this case, the quantizer 106 applies a regular scalar quantization to a spectrum data through a step-size which is usually varied based on a frame. The quantizer 106 is provided variable information about a QP by a QP adjuster 34 of an encoder QP controller 30 according to a frame in order to control the data rate.

An entropy coder 108 compresses the output from the quantizer 106 as well as specific additional information (e.g., motion information, a space extrapolation mode, and a quantization parameter) of a corresponding macroblock. An entropy coding technology which has been usually employed includes arithmetic coding, Huffinan coding, run-length coding, and Lempel Ziv (LZ) coding and so on. The entropy coder 108 ordinarily applies a specific coding technology to each type of information.

The video information compressed by the entropy coder 108 is buffered in a encoder buffer 110. A buffer level indicator of the encoder buffer 110 is provided to the encoder QP controller 30 in order to control the data rate. The video information stored in the encoder buffer 110 is output, for example, at a speed of a fixed transmission rate from the encoder buffer 110 and deleted.

In the meantime, when the reconstructed current frame mentioned above is necessary for successive motion estimation/motion compensation, a dequantizer 116 dequantizes the quantized spectrum coefficient. An inverse frequency converter 114 performs the inverse operation of the frequency converter 104 and creates an inverse difference macroblock from output of the dequantizer 116, for example, via an inverse DCT conversion. The inverse difference macroblock is not identical to the original difference macroblock due to influences of a signal loss, and so on.

When the current frame corresponds to an inter frame, the reconstructed inverse difference macroblock mentioned above is put together (combined) with the estimation macroblock of the ME/MC 120 and creates a reconstructed macroblock. The reconstructed macroblocks are stored in the frame storage memory 20 as a reference frame for use in estimation of the next frame. In this case, because the reconstructed macroblock is a distorted version of the original macroblock, discontinuity between macroblocks is smoothened by applying a deblocking filter 112 to the reconstructed frame in some embodiments of the present invention.

Meanwhile, a QP controller 30 controlling the QP of the encoder 10 includes a parameter updating unit 31 for updating various parameters used for controlling a frame rate through the current frame or reference frame etc., which have been stored in the frame storage memory 20, a target bit estimator 32 for estimating target bits in encoding the current frame through the updated parameters mentioned above, a QP calculating unit 33 for calculating an appropriate QP according to the updated parameters and the target bits, and a QP adjuster 34 for appropriately adjusting the QP of the quantizer 106 according to the updated parameters and the QP calculated by the QP calculating unit 33. According to the features of the present invention, the QP controller 30 further includes a complexity measuring unit 35 for measuring image complexity through the updated parameters mentioned above. The QP adjuster 34 reflects the image complexity measured by the complexity measuring unit 35 and adjusts the QP.

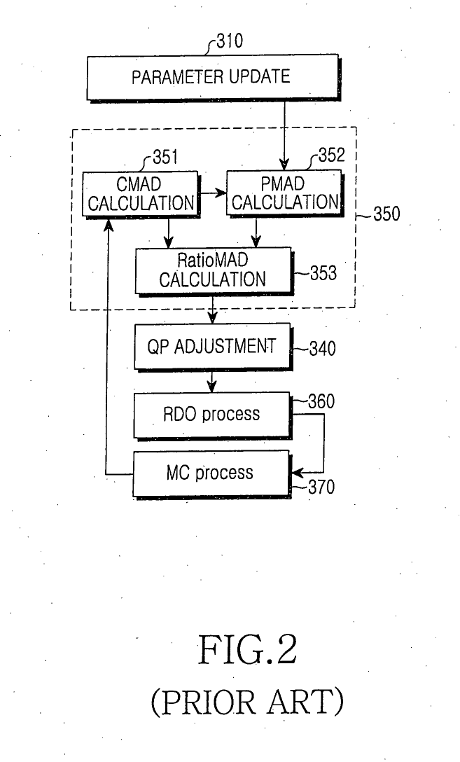

As disclosed in Jiang mentioned above, FIG. 2 is a flowchart illustrating an operation of measuring image complexity according to a conventional video encoding. Briefly, various parameters for controlling the frame rate are updated through the current frame and the reference frame in step 310, then image complexity is measured in step 350. In step 340, QP is appropriately adjusted using the measured complexity, then the Rate Distortion Optimization (RDO) process is performed according to the adjusted QP in step 360. Thereafter, the Motion Compensation (MC) process is performed in step 370. In this process, step 350 is performed by the complexity measuring unit 35, and step 340 is performed by the QP adjuster 34. Step 360 is performed by the frequency converter 104, the quantizer 106, and the entropy coder 108. Also, step 370 is performed by the ME/MC 120.

According to Equation (1) mentioned above, step 350 includes a sub-step of calculating the CMAD using error information between the reconstructed frame and a corresponding input frame of a preceding frame after execution of MC processing of step 370 (step 351), a sub-step of calculating the PMAD using variation states, etc. of the calculated CMADs of.the preceding frames (step 352), and a sub-step of calculating a ratio of the calculated PMAD to an average value of CMAD up to the preceding frame, thereby obtaining an RatioMAD, i.e., image complexity (step 353).

In the meantime, according to the teachings of the present invention mentioned above, however, the image complexity measured by the complexity measuring unit 35 is provided to the QP adjuster 34 and is used as some factors for adjusting the QP in the QP adjuster 34. Further, the image complexity is provided to the target bit estimator 32 or the QP calculating unit 33, such that the image complexity may be used either as a factor for estimating a target bit or as an additional factor for calculating QP.

Although the method of measuring image complexity mentioned above may have some similar steps disclosed in Jiang mentioned above, a notable difference is that there is no consideration of the header bit in Jiang as described above. That is, in the present invention, the image complexity CM is measured according to Equation (2) below in consideration of even the header bit.

CMᵢ=ε×RatioMVDᵢ+(1−ε)×RatioMADᵢ (2)

In Equation (2) mentioned above, RatioMAD is calculated according to a customary method described in Equation (1) mentioned above. The RatioMAD above corresponds to an image complexity parameter according to a feature of the present invention, wherein the image complexity parameter has been calculated by using header bits, especially, Motion Vector Difference (MVD) bits selected as bits best representing image motions among header bits. In Equation (2), ε is a weighting factor and appropriately adjusts the ratio between complexity values measured by using the header bits and by using the texture bits, and ‘i’ refers to an i^{th} frame. The RatioMVD mentioned above can be obtained according to Equation (3) below.

$${RatioMVD}_{i} = \frac{{AMVD}_{i - 1}}{\frac{1}{i - 1} {\sum }_{j = 1}^{i - 1} {AMVD}_{j}} \qquad ( 3 )$$

In Equation (3) above, AMVD represents an average value of all the macroblock MVD bits within a frame.

According to Equation (3) mentioned above, it can be understood that the RatioMVD of the current frame (i^{th}) is the ratio of the AMVD of the preceding frame to the average value of all the AMVDs up to the preceding frame.

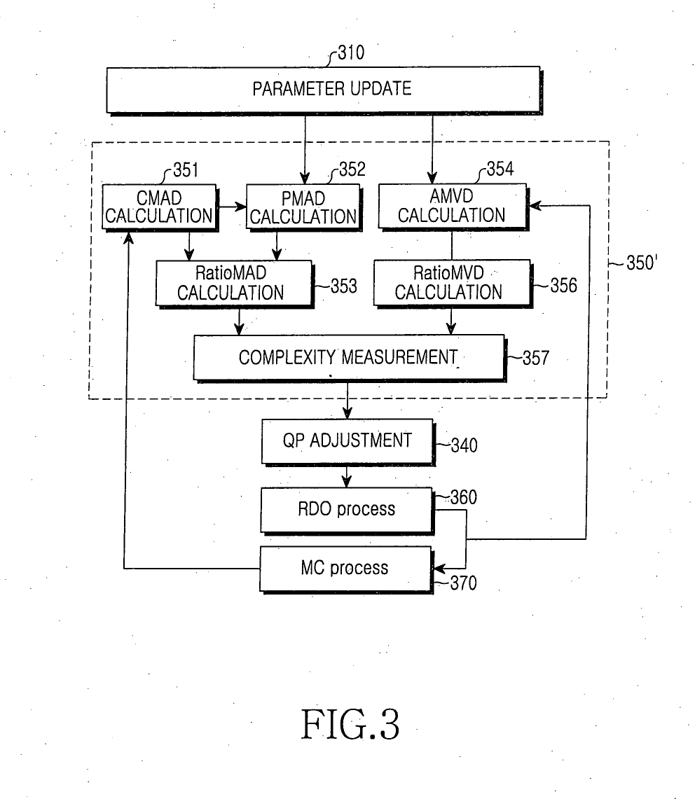

FIG. 3 is a flowchart illustrating an operation of measuring image complexity during video encoding according to an embodiment of the present invention. As shown, the operation illustrated in FIG. 3 includes updating various parameters (step 310), measuring the image complexity (step 350′), appropriately adjusting QP by using the measured complexity (step 340), performing the RDO process according to the adjusted QP (step 360), and then performing the MC process (step 370). In this case, step 350′ mentioned above is performed by the complexity measuring unit 35, step 340 is performed by the QP adjuster 34, and step 360 is performed by the frequency converter 104, the quanfizer 106, and the entropy coder 108. Also step 370 is performed by the ME/MC 120. Herein, the target bit estimator 32 or the QP calculating unit 33 may use the image complexity measured by the complexity measuring unit 35 as either a factor for estimating a target bit or an additional factor for calculating QP.

As the process illustrated in FIG. 2, according to Equation (1) mentioned above, step 350′ includes a sub-step of calculating the CMAD (step 351), a sub-step of calculating the PMAD (step 352), and a sub-step of calculating the RatioMAD (step 353). Additionally, with reference to Equation (2) and (3) mentioned above according to the embodiment of the present invention, step 350′ mentioned above further includes a sub-step of calculating the AMVD (step 354), a sub-step of calculating the RatioMVD (step 356), and a step of calculating final image complexity CM by using the RatioMAD and the RatioMVD (step 357).

If a first input is given an order of the Oth frame, the rate control generally has an effect on the 2^{nd} and higher frames. Accordingly, when the value i is higher than 2, equation (2) mentioned above is valid. When an image frame is input, the H.264/AVC performs the RDO by using a given Quantization Parameter (QP) value. An optimal mode has been selected after performing the RDO, header bits according to the selected optimal mode are obtained. In the present invention, the RatioMVD of Equation (3) mentioned above is obtained using MVD bit information among the header bits. The RatioMAD is calculated before the RDO process is performed. Image complexity is measured by combining the RatioMVD and the RatioMAD with Equation (3) above. Herein, although RatioMVD is not a value estimated using the current frame, it is possible to use the value for measurement of the real-time image complexity of the current frame. Particularly, the RatioMVD has a further significance when a high motion image (i.e., an image having a high image complexity) is continuous.

In the method of measuring image complexity according to the present invention as described above, it is possible to more accurately measure an image complexity in real time in an application field having a given low bit rate and a high frame rate. As a result, it is possible to achieve an improved video coding performance through efficient use of limited bit resources during the performance of the rate control.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

As described above, an operation of measuring image complexity according to an embodiment of the present invention can be performed. While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for measuring a real-time image complexity of an image processed for each macroblock based on a frame, the method comprising:
identifying a state of a preset value among header bits of information processed for each macroblock in a preceding frame;
identifying a state of the preset value among header bits of information processed for each macroblock up to a preceding frame; and
detecting image complexity of a current frame through comparison of the identified states.

2. The method as claimed in claim 1, wherein the preset value among the header bits corresponds to a Motion Vector Difference (MVD).

3. The method as claimed in claim 2, wherein the identified states is compared with each other by calculating a ratio of an average of all the macroblock MVDs of the preceding frame to an average of all the macroblock MVDs up to the preceding frame.

4. A method for measuring an image complexity of an image processed for each macroblock based on a frame, the method comprising:
identifying an average of state of a preset value among header bits of information processed for each macroblock in a preceding frame;
identifying an average of the preset value among header bits of information processed for each macroblock up to the preceding frame; and
detecting image complexity of a current frame through comparison of the identified states.

5. The method as claimed in claim 3, wherein the preset value among the header bits corresponds to a Motion Vector Difference (MVD).

6. A method for measuring an image complexity of an image processed for each macroblock based on a frame, the method comprising:
calculating RatioMAD, which represents an image complexity of texture bits, the image complexity corresponding to a ratio of an average value of actually Computed Mean Absolute Difference (CMAD), to Predicted Mean Absolute Difference (PMAD);
calculating image complexity of header bits corresponding to a ratio of an average value of an average of preset values among header bits of information processed for each macroblock in the preceding frame to an average of preset values among header bits of information processed for each macroblock up to the preceding frame; and
measuring image complexity of a current frame by using the image complexity of the texture bits and the image complexity of the header bits.

7. The method as claimed in claim 6, wherein a preset value among the header bits mentioned above corresponds to a Motion Vector Difference (MVD).

8. The method as claimed in claim 7, wherein RatioMVD, which represents the image complexity of the header bits, is calculated by
$${RatioMVD}_{i} = \frac{{AMVD}_{i - 1}}{\frac{1}{i - 1} {\sum }_{j = 1}^{i - 1} {AMVD}_{j}} , \qquad$$
wherein AMVD represents an average value of MVD bits of all macroblocks of a corresponding ordinal number (i^{th} or j^{th}) frame.

9. The method as claimed in claim 6, wherein the CMAD is calculated by using information about an error between corresponding input frame of the preceding frame and a reconstructed frame.

10. The method as claimed in claim 6, wherein the PMAD is calculated by using states of the calculated CMADs of the preceding frames.
